(19) United States
(12) Patent Application Publication
(10) Pub. No.: US 2015/0304363 A1
(43) Pub. Date: Oct. 22, 2015

(54) HIDDEN IDENTIFIERS FOR DEMULTIPLEXING AND RESOLUTION ARCHITECTURE

(71) Applicants: Jose Joaquin Garcia-Luna-Aceves, Santa Cruz, CA (US); Spencer Sevilla, Santa Cruz, CA (US)

(72) Inventors: Jose Joaquin Garcia-Luna-Aceves, Santa Cruz, CA (US); Spencer Sevilla, Santa Cruz, CA (US)

(73) Assignee: The Regents of the University of California, Oakland, CA (US)

(21) Appl. No.: 14/692,166

(22) Filed: Apr. 21, 2015

Related U.S. Application Data
(60) Provisional application No. 61/982,297, filed on Apr. 21, 2014.

(51) Int. Cl. H04L 29/06

(52) U.S. Cl. CPC H04L 65/1069

(57) ABSTRACT

A new and useful approach to binding network socket API using hidden identifiers, referred to by the acronym HIDRA (Hidden Identifiers for De-multiplexing and Resolution Architecture). HIDRA is the first solution that takes advantage of “hidden” identifiers to be used in hosts. HIDRA has three main components that integrate together: a protocol-agnostic API and stack; upgraded name-resolution and service-discovery functions; and transport-layer modifications. The hidden identifiers are de-multiplexed into open identifiers in lower protocol layers and open identifiers are resolved back into hidden identifiers in lower protocol layers for use by the application.

### RELATIONSHIP TO OTHER APPLICATIONS

The present application claims priority to and the benefit of U.S. Ser. No. 61/982,297 filed 21 Apr. 2014.

### GOVERNMENT FUNDING

None

### FIELD OF THE INVENTION

The presently disclosed subject matter is directed towards network socket Application Program Identifiers (APIs) for communications. More particularly, the subject invention is directed to a backward compatible socket API enhancement that addresses issues of mobility, multi-homing, and multiplexing by using hidden identifiers.

### BACKGROUND OF THE INVENTION

Today's network environment is rapidly changing. The rapid rise of mobile devices, some having multiple network interfaces creates mobility and multi-homing challenges that highlight the limitations of traditional network protocols. One simple example is that in the prior art a mobile device application had to reconnect to a network after a simple network handoff.

Issues impacting mobility and multi-homing challenges come about because of how applications send and receive messages over networks such as the Internet. In the prior art an application obtains two identifiers: the destination IP address, typically obtained by resolving a destination hostname through the DNS, and a tuple that identifies the transport port and protocol being used (usually known a-priori). After binding a network socket API to those identifiers, an application can send and receive messages. All other network concerns, such as the interface chosen or the route between the two hosts are selected established and maintained in the system and masked from the application.

The foregoing prior art approach has proven highly useful, but its limitations are becoming apparent. The identifiers that the application needs are “open” in that they are shared among all hosts acting as end points of the communication transactions and routers and relays which make up the communication connections. Open identifiers date back more than 30 years to the very inception of the Internet. Since the Internet was essentially built on identifiers making changes to the internet itself is highly problematic.

However, as the Internet has become ubiquitous and as wireless networks and devices have proliferated; modern application requirements make the traditional use of open identifiers for binding untenable. Multi-homing and mobility of processes requires seamlessly multiplexing among multiple network interfaces at each host and using diverse protocols in wired or wireless networks, things that cannot be easily accomplished today.

Broadly there are three types of mobility and multi-homing processes: terminal mobility, session mobility, and personal mobility. Terminal mobility refers to a single device having persisting sessions across interface and network-address changes. Session mobility refers to a user persisting a media session across different devices. Personal mobility refers to associating an individual user with several different devices. Currently, all approaches to session and personal mobility are enacted at the application layer, whereas terminal mobility can be accomplished through changes to routing, middle-boxes, or end-hosts (end-host solutions are usually favored).

An application running on a host and using open identifiers to bind to a socket API means that the socket binding cannot be changed by the network itself. A one-way street is created in which the application denotes a socket resource using the network-layer open identifiers which are also used by other hosts and routers. This approach fundamentally inhibits mobility and multi-homing and implicitly binds the host, the application, and the socket to a specified network-layer protocol (e.g., IPv4 or IPv6). In addition should any new network-layer protocol be implemented the application has to be rewritten to support it.

The foregoing problems also apply when using transport-layer open identifiers, and to the interface between the transport and network layers. Requiring applications to be rewritten to support a new transport-layer protocol presents an almost insurmountable hurdle to the adoption of any new transport-layer protocol. This is especially true when the deployment of a new transport-layer protocol is not synchronized or coordinated among hosts.

As if the foregoing limitations are not problems enough, while the congestion-control algorithm in TCP can readily adapt to route or interface change it cannot accommodate IP address changes. This is because TCP identifies connections using four open identifiers in the tuple (saddr, sport, daddr, and dport).

What is remarkable about the foregoing is that the network wide use of open identifiers does not arise from any intrinsic limitation of the socket API or the protocol stack. It is a self-inflicted wound. There is no fundamental reason why an application cannot be rewritten to accommodate a new network-layer protocol or why TCP cannot migrate across IP addresses: The limitations are unintended consequences of design decisions to use open identifiers to specify host resources.

As noted above binding names, addresses, and routes to one another goes back decades. A vast amount of work has been done on the subject over the years. But in essence the name of a resource is what is sought, a resource's address states where it is, and the route tells how to get there. An address is just a name of a lower-level entity and a socket API binding connects an application to the address. A binding between end-system names, addresses, and routes does not actually state how communications should be carried out, but it does assume that the same identifiers are used by both end systems and the relays between them.

The foregoing problems have been recognized by others. Some researchers have highlighted the issue that many new solutions simply cannot be deployed incrementally on a system that is decades old. Uniform adoption of some proposed solutions would be required. Some proposed solutions advocate a new Internet framework that allows for heterogeneity between different network domains. Some proposed solutions advocate a new network socket API. Some proposed solutions provide that future socket APIs should be based on host names, as opposed to network addresses. While conceptually such ideas may be technically workable, to get from where we are with an Internet that is used daily by hundreds of millions of people around the world and after an investment of hundreds of billions of dollars makes almost all such approaches effectively infeasible.

Rather than start from the ground up some researchers advocate the introduction of new layers of open identifiers into the protocol stack as a way of eliminating or reducing some of the naming and addressing problems in the current Internet architecture. For example, one proposal is that applications start with a service identifier (SID) that is provided by the end-user, resolve it to a set of endpoint identifiers (EID), and then choose one to bind to a socket API. EIDs are used only by the transport layer and are translated and bound to network addresses in order for routing and communication to occur. A similar proposal proposes the introduction of a Service Access Layer (SAL) between the network and the transport layers. The SAL would redirect the socket API to bind directly to service identifiers (SID) instead of to the traditional tuple of an IP address and a port number.

Another approach to network-layer support for terminal mobility and multi-homing proposes leaving end hosts (and transport protocols) unmodified and changing the routing infrastructure to forward packets to a host as it moves through the network. These proposals recognize that network identifiers currently serve two purposes: they identify an end host and locate it in the network. But most network-layer proposals share a fundamental characteristic of divorcing these two purposes and separating identification from location.

The foregoing approaches while technically supportable have noticeable disadvantages related to requiring support throughout the Internet core. Any mobile IP approach introduces a large amount of triangle-routing through a mobile node's Home Agent (HA). Avoiding triangle routing is possible but involves fragmenting the IP address space, resulting in unnecessarily large routing tables and overloading the meaning of an IP address as end hosts move throughout the network.

Much work has been done in adapting transport-layer protocols, in particular TCP, to support mobility and multi-homing So called “middle-box” proposals to change TCP/IP headers or behavior in-flight exist. Unfortunately, such approaches violate the Internet architectural design and introduce a transport-layer protocol bottleneck in which new protocols cannot be deployed because the middle-boxes would drop packets that use protocols they are not familiar with. In fact, traversing existing middle-box actions has become a primary challenge for any proposal that makes modifications above the network layer.

Another set of proposals modify the TCP to implement coordinating a handoff during a TCP session. Such proposals ensure security and provide a mechanism for TCP to preserve session information while changing values in the identifying tuple. This supports mobility (assuming that a handoff is anticipated in advance) but does not really help the more common case where disconnection occurs unexpectedly. Further, in-flight TCP change mechanisms are unable to multi-home or take advantage of prior knowledge regarding multiple network addresses, such as a DNS response containing several IP addresses. While work on in-flight handoff mechanisms is important and useful for supporting mobility, it is far from sufficient to address the foregoing concerns.

Another approach is to implement a multi-path TCP design that focuses addressing backwards-compatibility and middle-box traversals. Such designs center around applications communicating through “meta-sockets,” which in turn opens several simultaneous TCP sessions and stripes outgoing data across concurrent connections.

Still another approach is a proposed network stack architecture that translates a “host identifier”, such as a DNS hostname or HIP identity, into a “network locator” (e.g. an IPv4 address). Such proposals adapt the socket API and transport layer to bind directly to the host identifier, and then translate the identifier to the network locator between the transport and network layers. These architectures enable network-layer mobility and multi-homing, and are particularly appealing because they accomplish this without injecting an additional naming layer into the stack.

However, the host identifier is still open so the constraints of the chosen host identifier still apply. For example, DNS-based sockets cannot support environments where DNS is inappropriate, such as MANETs (mobile ad hoc networks), while other sockets cannot support resource-constrained environments such as sensor networks. Moreover, since all of these proposals translate between the transport and network layers, they are implicitly bound to the TCP/IP stack, and therefore cannot support alternate network stacks such as Bluetooth, Zigbee, or NFC. Thus, the foregoing proposals merely substitute one set of identifiers for another and remain fundamentally unable to support a wide range of future Internet proposals.

It is apparent from the foregoing that all proposals addressing the name-address binding limitations of the Internet assume that applications and protocols must bind themselves to “open identifiers” (e.g., IP addresses or SIDs) that are known “outside” the end systems or intermediate systems in which the applications and protocols run. Furthermore, assuming open identifiers are used at hosts and routers the only way to break the early binding between two layers is to introduce an additional layer of identifiers. This approach still locks the applications, the socket API, and newly proposed network APIs to the particular format of the open identifiers and the communication protocols using them. This is a problem in that just as the designers of the original Internet architecture could not predict today's problems associated with early bindings of names to addresses, it is not possible to predict what problems may result from the use of new open identifiers that must be unambiguous on a network-wide basis. An additional limitation is that for applications to use new open identifiers with the socket API application developers would have to modify their applications as the Internet evolves.

In view of the fact that the current protocol stack is sufficient to handle mobility, multiplexing and multi-homing issues, in further view of the fact that applications using open internet naming and addressing data to identify host resources create problems in the interaction between the application and the transport and network layers, in view of the limitations of proposed solutions to address the current problems, a new approach to specifying socket API resources would be beneficial.

While the foregoing has provided numerous definitions for various terms what follows are other definitions which are provided to assist the understanding the invention for those not intimately familiar with the current (circa 2014) understanding of various terms. What follows is not meant to unduly limit the invention The following definitions are not necessarily complete and there may be other definitions that are not provided either above or below. However, the reader hopefully will find the definitions contained herein useful.

API: Application Programming Interface, a description of how a software program should interact with other programs.

Bluetooth: a wireless UHF radio technology standard for exchanging data over short distances

DNS: a naming systems for computers and other resources on the Internet (or private networks). DNS allow a user to use easily remembered common domain names (e.g. uscs.edu) instead of the numerical addresses actually used for communications. The DNS acts like a phone book, you send it a name it responds with the numerical address.

Home Agent: a router on a mobile node's home network that maintains information about the node's current location.

IP address: a numerical label assigned to each device in a computer network that uses the Internet.

IPv4: an earlier network-layer communication protocol.

IPv6: the current network-layer communication protocol.

Multihoming: a computer or device connected to more than one computer network.

NAT box: a translater that maps open addresses and ports within a host to open addresses and ports known outside the network.

Network layer: the third of seven layers in the OSI model of computer networking. The network layer handles data packet forwarding and routing through intermediate routers.

NFC: a set of standards for radio communications using near fields.

Open identifier: an identifier shared among hosts or routers acting as end points or relays of end-to-end transactions or connections).

SID: a security identifier. A unique number representing an account on a computer.

Socket: an end point of a computer communication flow.

Socket API: an Application Programming Interface that allows software to control a socket.

TCP: Transmission Control Protocol; one of the communication protocols that comprise the Internet protocol. Among other tasks TCP breaks a data stream into IP-sized pieces, performs error checking and then sends the pieces. TCP resides in the transport layer and relieves an application from having to perform its own formatting and error checking.

Transport Layer: the fourth of seven layers in the OSI model of computer networking. The transport layer supports reliable arrival of messages and provides error checking mechanisms and data flow controls.

Zigbee: a specification for high level communication protocols that create personal area networks using low-power digital radios.

### BRIEF SUMMARY OF THE INVENTION

The present invention encompasses a new and useful approach to binding network socket API using hidden identifiers. Those hidden identifiers are used for host communication application programs. Those hidden identifiers are de-multiplexed into open identifiers in lower protocol layers and open identifiers are resolved back into hidden identifiers in lower protocol layers for use by the application.

For convenience the approach described herein is referred to as HIDRA (Hidden Identifiers for Demultiplexing and Resolution Architecture). HIDRA is the first solution that takes advantage of “hidden” identifiers to be used in hosts. HIDRA has three main components that integrate together: a protocol-agnostic API and stack; upgraded name-resolution and service-discovery functions; and transport-layer modifications.

HIDRA uses two protocol-agnostic hidden identifiers: a Transport Identifier (TID) and a Host Identifier (HID). When an application calls for a name-resolution or service-discovery function it receives a {TID, HID} tuple instead of the traditional {port, IP} tuple. The application uses the {TID, HID} tuple to specify the network socket API to send and receive messages. The operating system de-multiplexes hidden values in the {TID, HID} tuple to process the message. HIDRA introduction layers of indirection that enables applications to seamlessly migrate across network addresses and entire network protocols.

HIDRA enables sockets to evolve with the Internet by hiding all mobility, multi-homing, and multiplexing issues from applications; does not induce significant overhead in the protocol stack; preserves backwards compatibility with today's Internet and applications; and does not require or preclude any additional identifiers or protocols to be used in the protocol stack.

### BRIEF DESCRIPTION OF THE DRAWINGS

The advantages and features of the present invention will become better understood with reference to the following detailed description and claims when taken in conjunction with the accompanying drawings, in which:

FIG. 1 illustrates a communication network 10 that is suitable for practicing the present invention; and

FIG. 2 represents the seven layer model 100 of network communications; and

FIG. 3 illustrates HYDRA stack at end nodes.

FIG. 4 illustrates the process of sending and receiving messages.

FIG. 5 illustrates the process registration and binding a socket.

FIG. 6 illustrates name resolution and HID generation.

### DETAILED DESCRIPTION OF THE INVENTION

The presently disclosed subject matter now will be described more fully hereinafter with reference to the accompanying drawings in which one embodiment is shown. However, it should be understood that this invention may take different forms and thus the invention should not be construed as being limited to the specific embodiment set forth herein.

All documents and references and publications referred to in this disclosure are hereby incorporated by reference for all purposes. In the figures like numbers refer to like elements throughout. Additionally, the terms “a” and “an” as used herein do not denote a limitation of quantity, but rather denote the presence of at least one of the referenced items.

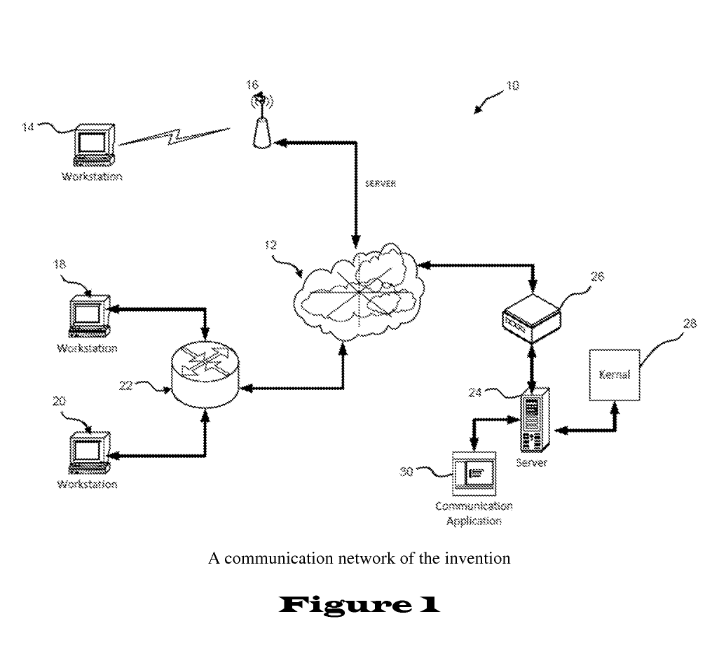

FIG. 1 illustrates a simplified network 10 for practicing the present invention. That network is assumed to be the internet, but other networks can also be used with the present invention. The network 10 includes the internet 12, a vast dispersed and diffused compilation of computers, cabling, wireless links, nodes repeaters, switches and other physical and conceptual elements the provided data communications between end points. The network includes a first workstation 14 that is connected by a wireless link 16 to the internet 12. Another workstation 18 and yet another work station 20 are connected to the internet 12 by a router 22. A host server 24 (a full computer system) is connected to the internet 12 by a switch 26. The host server 24 operates in accord with software, including an underlying Kernal 28 and a communication application 30.

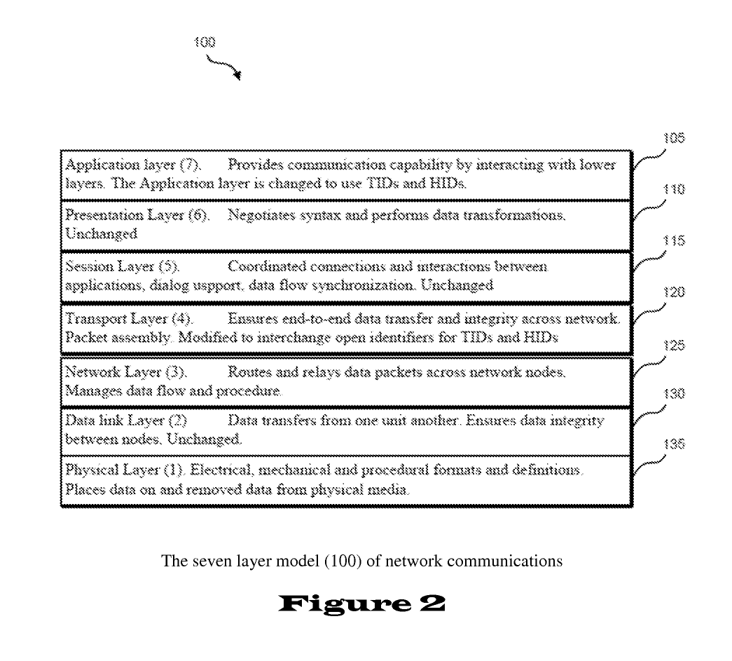

The various workstations 14, 17, and 20 and the server 24 conceptually follow the ISO seven layer model 100 shown in FIG. 2. That model 100 includes an application layer 105 which is interactive with the communication application 30. The model 100 further includes a presentation layer 110′ a Session layer 115; a transport layer 120; a network layer 125; a data link layer 130; and a physical layer 135.

It should be understood that the network 10 and the model 100 in the prior art operated using open identifiers that are needed for information dissemination to and from end systems (such as workstation 10 and the server 24) or intermediate systems (such as the router 22, the switch 26, and middle boxes if present). All destinations must be denoted unambiguously among all entities involved in any end-to-end data exchange so that messages can be forward the to their intended destinations. This means that two hosts on the same private network cannot share the same IP address or local DNS name. The present invention does not change the need for open identifiers below the transport layer 120 and between stations. What the present invention does change is the understandings that open identifiers have global meanings.

All prior art Internet architectures used open identifiers exclusively. At first glance, this may appear to be a trivial and fully acceptable choice given that open identifiers are required to disseminate information across end systems (such as workstation 10 and the server 24) and intermediate systems (such as the router 22, the switch 26, and middle boxes if present). However, it is possible to decouple the internal management of resources above that data link layer 130 at an end system or intermediate system from the way multiple systems otherwise collaborate to share information. Requiring open identifiers for internal purposes within end systems ties applications and higher-level protocols to the specific protocols and identifiers used for information exchange. This significantly inhibits the deployment of new networking approaches in the prior art.

The present invention allows applications to use “hidden identifiers” to denote resources and destinations within the host (the server 24) in which they run. Because open identifiers are needed for communication between end systems, the host stack of the server 24 uses hidden identifiers that are translated into and recovered from the open identifiers needed for communications.

Mapping open addresses and ports within a host (the server 24) that is on one network into open addresses and ports outside that network in the prior art was done using network address translation (NAT) boxes. However, hidden identifiers apparently have never been used in any network 10 architecture within a host (the server 24).

While socket APL hidden identifiers are new, hidden identifiers themselves are not. File descriptors were originally designed in UNIX to provide a standard interface for applications in a way that did not depend on either the physical location of the file or the addressing scheme. Before file descriptors, applications had to be written for specific hardware profiles. Given that minor changes in hardware broke all file applications this created a major roadblock to innovation. That problem is analogous to the state of network programming today in which changes in network addresses such as a disrupted connectivity and changes in network protocols require applications to be rewritten.

Modern file descriptors allow applications to remain ignorant of lower-level concerns. This has enabled innovations in both file system and hardware design. Similarly, hidden identifiers in the socket API provides an architectural solution to naming and addressing problems in today's Internet and other networks by allowing different socket API components to evolve and change independently of each other. In contrast, a socket API based on open identifiers is not nearly as modular because as designed an application using an open identifier must specify both the identifier and its format. This binds the application to whatever values were supplied and forces the application to deal with any change in either value.

HIDRA is a solution to the problem-spaces described above. HIDRA is based on two main principles. The first being that hosts (such as the server 24) can denote Internet resources internally using hidden identifiers. This decouples communication applications 30 running on a host (the server 24) from the host's network layer 125 and transport layer 120 and from the open identifiers they use to disseminate information. The second principle is that hosts (the server 24) map those hidden identifiers to and from open identifiers in a way that preserves the existing functionality of the network and transport layers.

HIDRA adds indirection between the host's network layer 125, transport layer 120, and the application layer 105, which results in the core TCP/IP stack and intermediate systems being unmodified while enabling support for mobility and multi-homing HIDRA also supports incremental evolution and deployment of new networking technologies in layers that were previously considered to be converged-upon and un-modifiable.

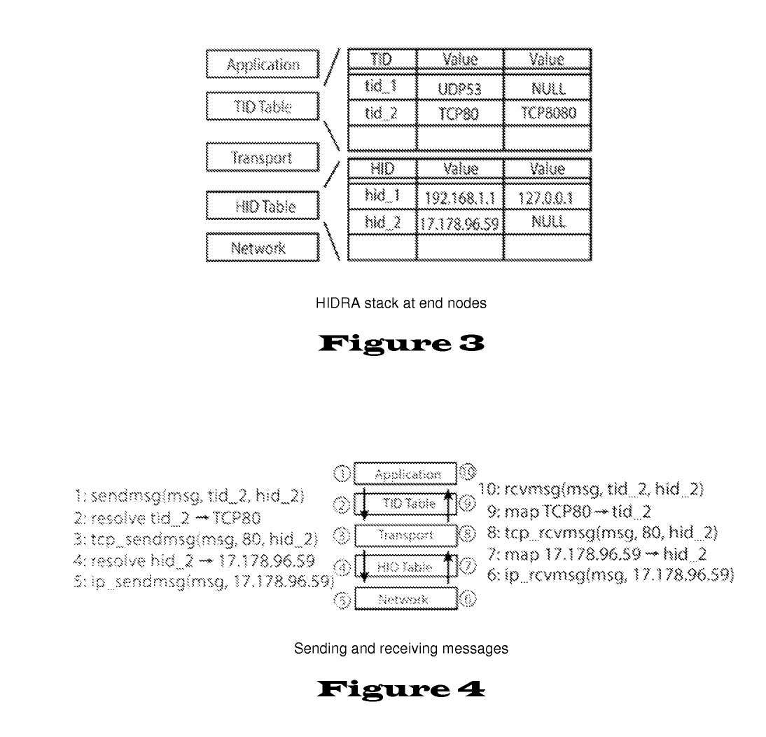

FIG. 3 illustrates the HIDRA network stack at an end system which uses two tables to manage two separate hidden identifiers. Applications communicate with a socket APL using a {TID, HID} tuple. The TID table bridges communication between the socket APL and the transport layer 120 such that the transport layer 120 can use a protocol-specific open identifier and a HID. The HID table bridges communication between the transport layer 120 and network layer 125 in the same way.

Before an application uses a HIDRA socket APL the communication application 30 must first obtain a TID and HID. This mimics the way today's applications call getaddrinfo to translate a DNS hostname to a set of IP addresses. The communication application 30 obtains the TID and HID through a name-resolution or service-discovery function. This process is discussed in more detail subsequently.

Once a communication application 30 acquires a TID and HID the communication application 30 uses those to send messages through the HIDRA socket API, reference steps 1-5 of FIG. 4. An application sends messages by calling sendmsg, but the application passes a TID and HID instead of the traditional tuple to the HIDRA socket API, step 1. The host system translates the TID, step 2, and passes the message to the appropriate transport layer 120 protocol, step 3. The transport protocol 120 processes the message and creates a datagram addressed to the HID, step 3. When the transport protocol 120 is finished the HID is translated to an open network address, step 4, and the network layer 125 processes the packet normally, step 5.

While FIG. 4 shows the TCP at the transport layer and IPv4 at the network layer, in practice HIDRA neither requires nor enforces either decision. Rather, the TID and HID could represent any one of several transport or network protocols, including those that do not normally coexist with the traditional TCP/IP stack, such as Bluetooth.

In the prior art an application receives messages by first binding a socket to a local IP address, transport protocol, and port. To enable the communication application 30 to bind across all local IP addresses the socket API provides an INADDR_ANY macro for IPv4, and an INADDR6_ANY for IPv6. Then the communication application 30 publishes the identifiers that it has registered. This step is crucial because every outgoing connection must somehow know its destination. Despite its importance this step is often either overlooked or executed in an ad-hoc manner such as by manually configuring a DNS server or by relying on an a priori understanding that well-known ports correspond to certain services.

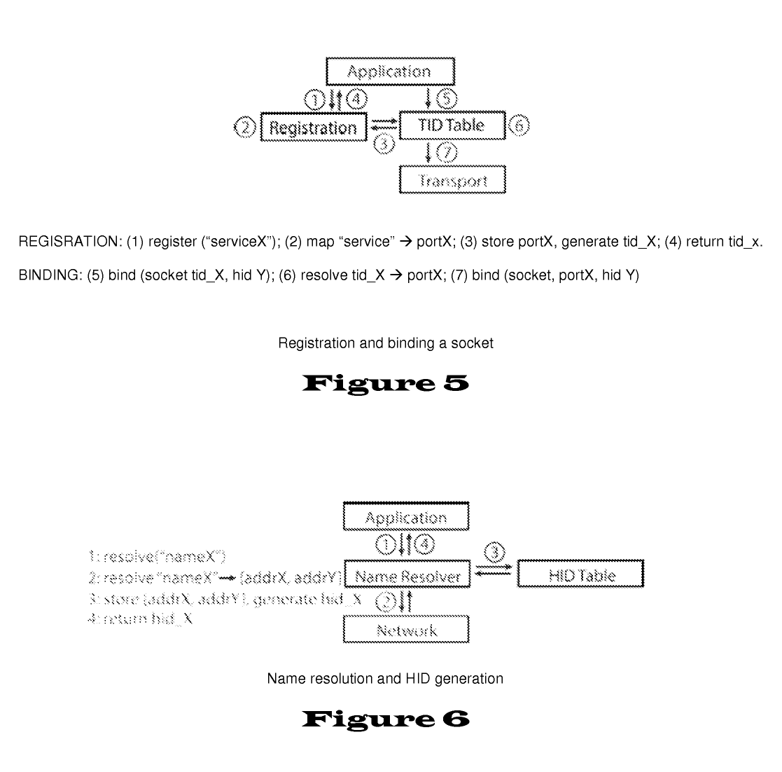

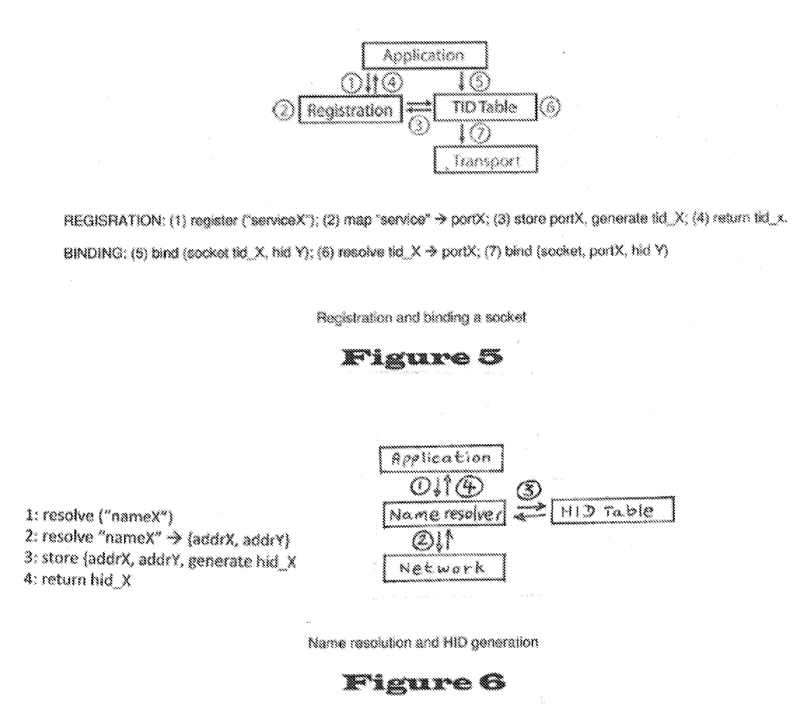

HIDRA abstracts protocols and identifiers away from the communication applications 30 by leveraging the publishing of identifiers. Rather than binding to protocol-specific identifiers such as ports and addresses, HIDRA depends on peripheral registration functions to complement the name-resolution functions. Under HIDRA, communication application 30 use their registration functions to advertise a particular service and, upon successful registration, receive a TID and a HID. The application binds a HIDRA socket APL using the TID and HID. The TID and HID are then de-multiplexed to complete the binding. This process is illustrated in FIG. 5.

Once a communication application 30 binds a HIDRA socket APL the communication application 30 can receives messages using the inverse of the process of sending messages. The receiving process is illustrated in Steps 6-10 of FIG. 4. After the network layer has processed a data packet, step 6, the source network address is multiplexed to a HID, step 7. If no entry exists in the HID table, which may because of a server accepting incoming connections, a new HID is generated. The transport layer 120 then processes the packet, step 8, multiplexes the port to a TID, step 9, and finally queues the message for delivery to the appropriate socket, step 10.

By design, HIDRA masks the transport layer 120 and network layer 125 identifiers from the communication application 30. Although the communication application 30 usually has no need to inspect its identifiers, it can be necessary. For example, a tool designed to test the connectivity of a particular network protocol may not work if HIDRA masks and changes the identifiers.

HIDRA provides supports for an application that wishes to examine its identifier in two ways. First, HIDRA supports manually creating and editing TID and HID entries through an exposed APL. Second, HIDRA sockets are created through a new socket family, AF_HIDRA that can coexist with traditional sockets based on open identifiers.

HIDRA achieves its benefits by masking network protocols and identifiers from the communication application 30. However, HIDRA cannot completely mask all identifiers because the communication application 30 must still somehow specify the network resource or service it wishes to communicate with. In HIDRA this process is accomplished through name resolution and service discovery functions.

HIDRA upgrades name resolution and service discovery to an integral part of network communications and relies on such functions to translate a user-friendly identity, such as a hostname, into a TID and HID. This supports applications being address- and protocol-agnostic by identify network services, resources, and applications through a user-friendly identifier.

In the prior art name resolution and service discovery protocols typically translated a user-friendly identifier such as a hostname into a set of transparent identifiers which were then returned to the application. In HIDRA, that basic idea remains the same, but instead of returning transparent identifiers directly to the communication application 30 HIDRA interacts with the TID or HID table to store these entries. A corresponding TID or HID is then generated and sent to the application. This process is illustrated for DNS in FIG. 6.

FIG. 6 also presents a limitation of DNS: DNS only provides the application with IP addresses, not ports. In the prior art such resolution or discovery methods was not implemented for transport protocols. The prior art essentially implemented a “magic numbers” approach that it simply relied on well-known ports corresponding to certain services, such as TCP80 or UDP53. This created an entire new set of problems and solutions such as NAT hole-punching and middle-box traversals.

One basic approach for TID table-population is to create a TID that corresponds directly to a transport protocol and identifier. This can be done using a simple helper method such as generate_tid(TCP80). However, other discovery protocols, such as the mDNS-SD service registry are designed to enable applications to reference a service provided on a host by using a string name, such as _http or _printer. For these protocols the TID table provides a natural point to aggregate and manage identifiers. Moreover, the TID table supports future work in discovery and resolution of ports and other transport-layer identifiers. For example, NAT traversal might be made simpler through dynamically-generated and changed ports.

As with any service-discovery or name-resolution protocol HIDRA provides a mechanism for registration, whether using explicit (e.g. a callback function) or implicit (e.g. manual server configuration). For TID generation, HIDRA requires explicit registration. The registration function populates the TID table and generates a TID through either static or dynamic means. Until such protocols fully evolve, HIDRA implements an immediate solution through creating a simple helper function such as register_local_tid(TCP80).

As shown in FIG. 5, the registration function only returns a TID. This is because, in contrast to today's Internet model, binding in HIDRA does not require a local network address. Rather, HIDRA masks network-layer concerns from the communication application 30 and assumes that the communication application 30 intends to bind the HIDRA socket APL across all local addresses of all network protocols simultaneously. This can include new interfaces as they emerge or come online A communication application 30 indicates this using the HID_ANY macro (which resembles a protocol-agnostic version of INADDR_ANY). Where this behavior is unwanted a communication application 30 can generate a HID that corresponds to a particular subset of local network addresses through a peripheral registration function, and then bind a socket as described above. In addition to maintaining the socket API is why HIDRA requires a HID to be passed to the bind( ) syscall.

After the TID and HID tables are populated their entries must be managed, changed, and removed as appropriate. To accomplish this HIDRA follows the model of file descriptors and keeps TID and HID tables separate. This enables the system to decide when old entries should be cleaned out and speeds up the individual lookup process since each per-process table is smaller than one large global table.

This architecture also has significant implications for security. By restricting all transparent identifiers to kernelspace, and keeping separate tables per-process, the risk of table cross-contamination or exposing information from one application to another is mitigated.

By design HIDRA uses resolution and registration functions instead of simply extending the existing socket API to support operations such as bind and connect on higher-level identifiers. This design not only supports a wide range of protocols and input values but also enables asynchronous deployment of new resolution and discovery protocols. Supporting new protocols is important because prior art resolution and discovery protocols are typically bound to a particular network stack or protocol. DNS and mDNS provide only IP addresses, Bluetooth specifies its own service-discovery protocol, and so do Zigbee and NFC. The prior art resulted in a fragmentation that is not an inherent part of any protocol but as an artifact of how inflexible the prior art socket API was.

Despite HIDRA's flexibility prior art fragmentation means that existing protocols must be updated to reflect the more-dynamic HIDRA socket API or new resolution protocols must be put in place to bridge the gap. This is because selecting a prior art name-resolution protocol implicitly selects the network stack. Updating name resolution protocols to support alternative network identifiers (i.e. a mDNS daemon also providing a Zigbee address or the NFC SDP also returning a Bluetooth ID) is a straightforward process. Thus HIDRA provides a natural interface for developing both new protocols and extensions of existing protocols.

Prior art name-resolution protocols can be considered “host-centric” in that they primarily focus on resolving the name of a host or node (e.g. “Spencer's MacBook Air”) to its network location. Since HIDRA effectively hides the stack implementation from communication applications 30 running on a host, HIDRA provides an interface that can incorporate new architectures and abstracts problems away from the communication application 30. HIDRA supports information-centricity through new resolution and registration functions that map requests for named-data objects (NDOs) to TID/HID tuples that represent where an information-centric object can be found.

This is possible because TIDs and HIDs are by definition meaningless values until they are multiplexed. Thus new and different network architectures may use them in radically different ways.

To implement HIDRA, existing transport layer 120 protocols must be adapted to use HIDs as opposed to open network addresses. This represents a minor shift for UDP since it maintains no state or connection information. However, proper implementation requires changes to TCP. This is because HIDRA implicitly changes the (saddr, sport, daddr, dport) tuple used by TCP in the prior art to identify and lookup connections.

When an application sends data to TCP the HIDRA socket APL connection is already known. Thus the destination HID needs to be multiplexed to an open network identifier. Such is trivial. However, when receiving data the TCP must lookup the corresponding connection to process the packet. This is a problem because HIDRA changes the TCP tuple for incoming lookups in two key ways: first, the foreign address (saddr for incoming packets) is replaced by a HID by the time TCP sees the packet. Second, the local address is completely removed from the lookup. This is because HIDRA masks this from the transport layer.

In view of the foregoing the lookup for established connections consists of a (hid, sport, dport) tuple while the lookup for listening connections is based on the destination port. This shift supports address multi-homing and mobility by masking the network address from the transport layer, thus keeping TCP unaware of network-layer changes. HIDRA appears to be the first approach to accomplishing this without introducing any new protocols or naming layers in the stack. HIDRA is completely transparent to other hosts in that HIDRA does not modify the TCP packets that are sent “over the wire”. While HIDRA does not change TCP packets or introduce any extra signaling HIDRA does provides an architecture that supports such modifications.

An implementation of HIDRA on a Linux 3.0.x kernel module has been developed. To generate TIDs and HIDs, helper functions to interact with and populate the TID and HID tables were written. A new socket family, AF_HIDRA and the (TID, HID) tuple subtype of the generic sockaddr structure was implemented. Defining the tuple this way left the generic socket API fully intact while still affording a large address space (14 bytes) for the TID and HID. The TID and HID table implementation obey a policy for address-selection: rank addresses in the same order they are entered into the table. If an error such as EHOSTUNREACH is encountered the offending address is removed and the message is resent using the next address. Errors were returned to the application only when no more addresses existed. The implementation requires about 600 lines of original code, most of which is devoted to managing the TID and HID tables.

It is to be understood that while the figures and the above description illustrate the present invention, they are exemplary only. They are not intended to be exhaustive or to limit the invention to the precise forms disclosed, and obviously many modifications and variations are possible in light of the above teaching. Others who are skilled in the applicable arts will recognize numerous modifications and adaptations of the illustrated embodiments that remain within the principles of the present invention. Therefore, the present invention is to be limited only by the appended claims.

Publications by the inventors incorporated by reference include the following:
S. Sevilla, J. J. Garcia-Luna-Aceves, “HIDRA: Hiding Mobility, Multiplexing, and Multi-Homing from Internet Applications,” to be presented at the IEEE INFOCOM 2014 Global Internet Symposium
S. Sevilla, P. Mahadevan, J. J. Garcia-Luna-Aceves, “iDNS: Enabling Information Centric Networking Through The DNS,” to be presented at the IEEE INFOCOM 2014 Workshop on Name-Oriented Mobility
S. Sevilla, J. J. Garcia-Luna-Aceves, “Allowing Applications To Evolve With The Internet: The Case For Internet Resource Descriptors,” to be presented at IEEE ICC 2014
S. Sevilla, P. Mahadevan, J. J. Garcia-Luna-Aceves, “FERN: A Unifying Framework for Name Resolution Across Heterogeneous Architectures,” Proc. IFIP Networking 2013
M. Xia, M. Tornatore, S. Sevilla, L. Shi, C. Martel, “A Novel SLA Framework for Time-Differentiated Resilience in Optical Mesh Networks,” IEEE Journal of Optical Communications and Networking, Vol. 3, Issue 4, 2011.
S. Sevilla, M. Xia, C. Martel, B. Mukherjee, “Time-Differentiated Resilience in Telecom Mesh Networks,” Proc. ICC 2011, Kyoto, Japan.

1. A method for network communication, comprising the steps of:
(i) providing a computer having an operating system that implements a seven layer communication model;
(ii) connecting the computer to a network;
(iii) running a communication application on the computer;
(iv) requesting a set of hidden identifiers for use by the communication application;
(v) requesting a set of open identifiers for enabling communications with an end point over the network;
(vi) sending a communication to the transport layer using hidden identifiers;
(vii) translating the hidden identifiers to open identifiers and sending the communication to the network layer; and
(vii) transmitting the communication to the end point using open identifiers.

2. The method according to claim 1, wherein the network includes a router.

3. The method according to claim 1, wherein the communication is sent over a wireless link.

4. The method according to claim 3, wherein the hidden identifiers are processed by the operating system kernal.

5. The method according to claim 4, wherein the hidden identifiers include a Transport Identifier and a Host Identifier.

6. The method according to claim 4 wherein the open identifiers include an IP address.

7. A method of network communications, comprising:
(i) providing a computer having an operating system that implements a seven layer communication model;
(ii) connecting the computer to a network;
(iii) running a communication application on the computer;
(iv) requesting a set of hidden identifiers for use by the communication application;
(v) requesting a set of open identifiers for enabling communications with an end point over the network;
(vi) receiving a communication over the network having open identifiers;
(vii) translating the open identifiers to hidden identifiers and passing the translated communication to the communication application.

8. The method according to claim 7, wherein the network includes a router.

9. The method according to claim 7, wherein the communication is sent over a wireless link.

10. The method according to claim 9, wherein the open identifiers are processed by the operating system kernal to obtain hidden identifiers.

11. The method according to claim 9, wherein the hidden identifiers include a Transport Identifier and a Host Identifier.

12. The method according to claim 9 wherein the open identifiers include an IP address.
